(19) United States
(12) Patent Application Publication
(10) Pub. No.: US 2003/0088678 A1
(43) Pub. Date: May 8, 2003

(54) Virtual attribute service in a directory server

(76) Inventors: David W. Boreham, Livingston, MT (US); Pete Rowley, Ben Lomond, CA (US); Mark C. Smith, Saline, MI (US)

Correspondence Address: ROSENTHAL & OSHA L.L.P., 1221 MCKINNEY AVENUE, SUITE 2800, HOUSTON, TX, 77010, US

(21) Appl. No.: 09/993,920

(22) Filed: Nov. 6, 2001

(51) Int. Cl. G06F 15/16

(52) U.S. Cl. 709/228; 709/203

(57) ABSTRACT

A virtual attribute service in a directory server including an attribute value associated with an entry, a virtual attribute service provider, and an interface using the virtual attribute service provider to generate the attribute value associated with the entry.

### BACKGROUND OF INVENTION

The most fundamental program resident on any computer is the operating system (OS). Various operating systems exist in the market place, including Solaris™ from Sun Microsystems Inc., Palo Alto, Calif. (Sun Microsystems), MacOS from Apple Computer, Inc., Cupertino, Calif., Windows® 95/98 and Windows NT®, from Microsoft Corporation, Redmond, Wash., UNIX, and Linux. The combination of an OS and its underlying hardware is referred to herein as a “traditional platform”. Prior to the popularity of the Internet, software developers wrote programs specifically designed for individual traditional platforms with a single set of system calls and, later, application program interfaces (APIs). Thus, a program written for one platform could not be run on another. However, the advent of the Internet made cross-platform compatibility a necessity and a broader definition of a platform has emerged. Today, the original definition of a traditional platform (OS/hardware) dwells at the lower layers of what is commonly termed a “stack,” referring to the successive layers of software required to operate in the environment presented by the Internet and World Wide Web.

Effective programming at the application level requires the platform concept to be extended all the way up the stack, including all the new elements introduced by the Internet. Such an extension allows application programmers to operate in a stable, consistent environment.

iPlanet™ E-commerce Solutions, a Sun Microsystems|Netscape Alliance, has developed a net-enabling platform shown in FIG. 1 called an Internet Service Deployment Platform (ISDP) (28). ISDP (28) gives businesses a very broad, evolving, and standards-based foundation upon which to build an e-enabled solution.

A core component of the ISDP (28) is iPlanet™ Directory Server (80), a Lightweight Directory Access Protocol (LDAP)-based solution that can handle more than 5,000 queries per second. iPlanet™ Directory Server (iDS) provides a centralized directory service for an intranet or extranet while integrating with existing systems. The term “directory service” refers to a collection of software, hardware, and processes that store information and make the information available to users. The directory service generally includes at least one instance of the iDS and one or more directory client program(s). Client programs can access names, phone numbers, addresses, and other data stored in the directory.

The iDS is a general-purpose directory that stores all information in a single, network-accessible repository. The iDS provides a standard protocol and application programming interface (API) to access the information contained by the iDS. The iDS provides global directory services, meaning that information is provided to a wide variety of applications. Until recently, many applications came bundled with a proprietary database. While a proprietary database can be convenient if only one application is used, multiple databases become an administrative burden if the databases manage the same information. For example, in a network that supports three different proprietary e-mail systems where each system has a proprietary directory service, if a user changes passwords in one directory, the changes are not automatically replicated in the other directories. Managing multiple instances of the same information results in increased hardware and personnel costs.

The global directory service provides a single, centralized repository of directory information that any application can access. However, giving a wide variety of applications access to the directory requires a network-based means of communicating between the numerous applications and the single directory. The iDS uses LDAP to give applications access to the global directory service.

LDAP is the Internet standard for directory lookups, just as the Simple Mail Transfer Protocol (SMTP) is the Internet standard for delivering e-mail and the Hypertext Transfer Protocol (HTTP) is the Internet standard for delivering documents. Technically, LDAP is defined as an on-the-wire bit protocol (similar to HTTP) that runs over Transmission Control Protocol/Internet Protocol (TCP/IP). LDAP creates a standard way for applications to request and manage directory information.

An LDAP-compliant directory, such as the iDS, leverages a single, master directory that owns all user, group, and access control information. The directory is hierarchical, not relational, and is optimized for reading, reliability, and scalability. This directory becomes the specialized, central repository that contains information about objects and provides user, group, and access control information to all applications on the network. For example, the directory can be used to provide information technology managers with a list of all the hardware and software assets in a widely spanning enterprise. Most importantly, a directory server provides resources that all applications can use, and aids in the integration of these applications that have previously functioned as stand-alone systems. Instead of creating an account for each user in each system the user needs to access, a single directory entry is created for the user in the LDAP directory. FIG. 2 shows a portion of a typical directory with different entries corresponding to real-world objects. The directory depicts an organization entry (90) with the attribute type of domain component (dc), an organizational unit entry (92) with the attribute type of organizational unit (ou), a server application entry (94) with the attribute type of common name (cn), and a person entry (96) with the attribute type of user ID (uid). All entries are connected by the directory.

Understanding how LDAP works starts with a discussion of an LDAP protocol. The LDAP protocol is a message-oriented protocol. The client constructs an LDAP message containing a request and sends the message to the server. The server processes the request and sends a result, or results, back to the client as a series of LDAP messages. Referring to FIG. 3, when an LDAP client (100) searches the directory for a specific entry, the client (100) constructs an LDAP search request message and sends the message to the LDAP server (102) (step 104). The LDAP server (102) retrieves the entry from the database and sends the entry to the client (100) in an LDAP message (step 106). A result code is also returned to the client (100) in a separate LDAP message (step 108).

LDAP-compliant directory servers like the iDS have nine basic protocol operations, which can be divided into three categories. The first category is interrogation operations, which include search and compare operators. These interrogation operations allow questions to be asked of the directory. The LDAP search operation is used to search the directory for entries and retrieve individual directory entries. No separate LDAP read operation exists. The second category is update operations, which include add, delete, modify, and modify distinguished name (DN), i.e., rename, operators. A DN is a unique, unambiguous name of an entry in LDAP. These update operations allow the update of information in the directory. The third category is authentication and control operations, which include bind, unbind, and abandon operators.

The bind operator allows a client to identify itself to the directory by providing an identity and authentication credentials. The DN and a set of credentials are sent by the client to the directory. The server checks whether the credentials are correct for the given DN and, if the credentials are correct, notes that the client is authenticated as long as the connection remains open or until the client re-authenticates. The unbind operation allows a client to terminate a session. When the client issues an unbind operation, the server discards any authentication information associated with the client connection, terminates any outstanding LDAP operations, and disconnects from the client, thus closing the TCP connection. The abandon operation allows a client to indicate that the result of an operation previously submitted is no longer of interest. Upon receiving an abandon request, the server terminates processing of the operation that corresponds to the message ID.

In addition to the three main groups of operations, the LDAP protocol defines a framework for adding new operations to the protocol via LDAP extended operations. Extended operations allow the protocol to be extended in an orderly manner to meet new marketplace needs as they emerge.

The basic unit of information in the LDAP directory is an entry, a collection of information about an object. Entries are composed of a set of attributes, each of which describes one particular trait of an object. Attributes are composed of an attribute type (e.g., common name (cn), surname (sn), etc.) and one or more values. FIG. 4 shows an exemplary entry (124) showing attribute types (120) and values (122). Attributes may have constraints that limit the type and length of data placed in attribute values (122). A directory schema places restrictions on the attribute types (120) that must be, or are allowed to be, contained in the entry (124).

### SUMMARY OF INVENTION

In general, in one aspect, the invention involves a virtual attribute service in a directory server. The virtual attribute comprises an attribute value associated with an entry, a virtual attribute service provider and an interface using the virtual attribute service provider to generate the attribute value associated with the entry.

In general, in one aspect, the invention involves a method of generating a value of a virtual attribute comprising calling a virtual attribute service by an executable application, and consulting a virtual attribute service provider within a common interface of the virtual attribute service. The value of the virtual attribute is generated by the virtual service provider accessed by the common interface.

In general, in one aspect, the invention involves a method of generating a value of a virtual attribute comprising calling a virtual attribute service by an executable application, consulting a virtual attribute service provider within a common interface of the virtual attribute service, using a memory cache to store the value of the virtual attribute, maintaining a count for the number of times a query passes through the common interface, flagging an error and aborting the execution of the virtual attribute service if the count exceeds a threshold number, checking a configuration change within a service provider against the configuration of all service providers, determining whether a cycle is created, and flagging an error and aborting the execution of the virtual attribute service if a cycle is created. The value of the virtual attribute is generated by the virtual service provider accessed by the common interface.

In general, in one aspect, the invention involves a class of service in a directory server. The class of service comprises a definition entry identifying a type of class of service, and a dynamic template entry storing a list of the shared attribute values. The definition entry and the dynamic template entry interact to provide an attribute value to a target entry.

In general, in one aspect, the invention involves a method for generating an attribute value of a class of service in a directory server. The method comprises identifying a dynamic template entry by a distinguished name, adding a specific attribute to the dynamic template entry, and generating the attribute value of the dynamic template entry while a client application is accessing the directory server.

In general, in one aspect, the invention involves a method for generating an attribute value of a class of service in a directory server. The method comprises identifying a dynamic template entry by an attribute value of a target entry, adding a specific attribute to the dynamic template entry, and generating an attribute value of the dynamic template entry while a client application is accessing the directory server.

In general, in one aspect, the invention involves a method for generating an attribute value of a class of service in a directory server. The method comprises identifying a dynamic template entry by a distinguished name and an attribute value of a target entry, adding a specific attribute to the dynamic template entry, and generating an attribute value of the dynamic template entry while a client application is accessing the directory server.

In general, in one aspect, the invention involves an apparatus for generating a value of a virtual attribute. The apparatus comprises means for calling a virtual attribute service by an executable application, means for consulting a virtual attribute service provider within a common interface of the virtual attribute service. The value of the virtual attribute is generated by the virtual service provider accessed by the common interface.

Other aspects and advantages of the invention will be apparent from the following description and the appended claims.

### BRIEF DESCRIPTION OF DRAWINGS

FIG. 1 illustrates a block diagram of iPlanet® Internet Service Development Platform.

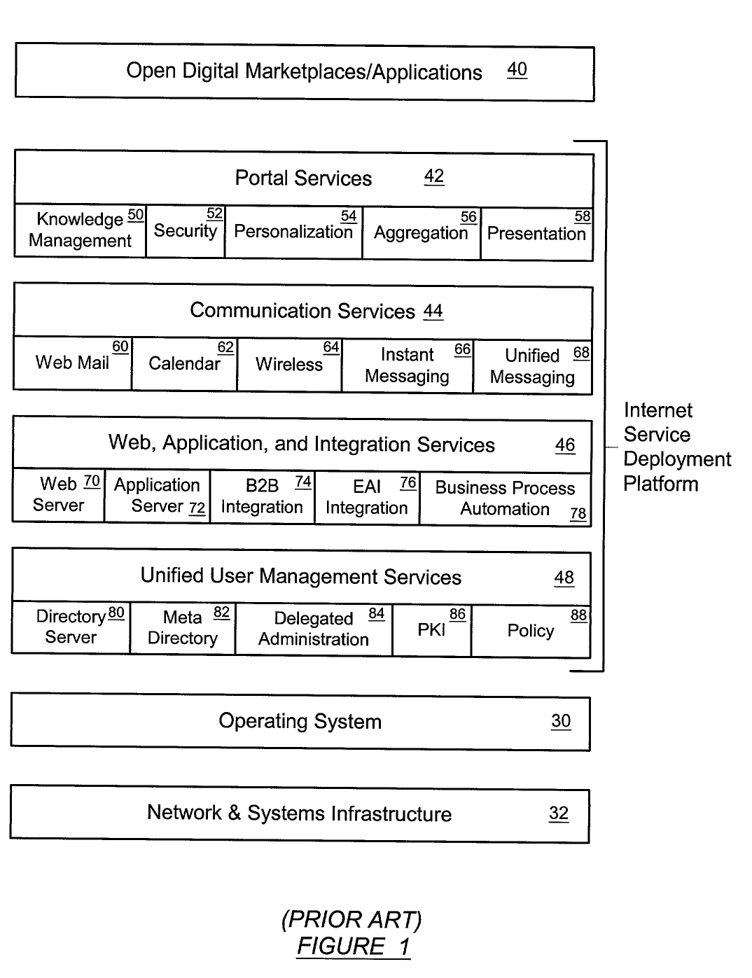

FIG. 2 illustrates part of a typical directory.

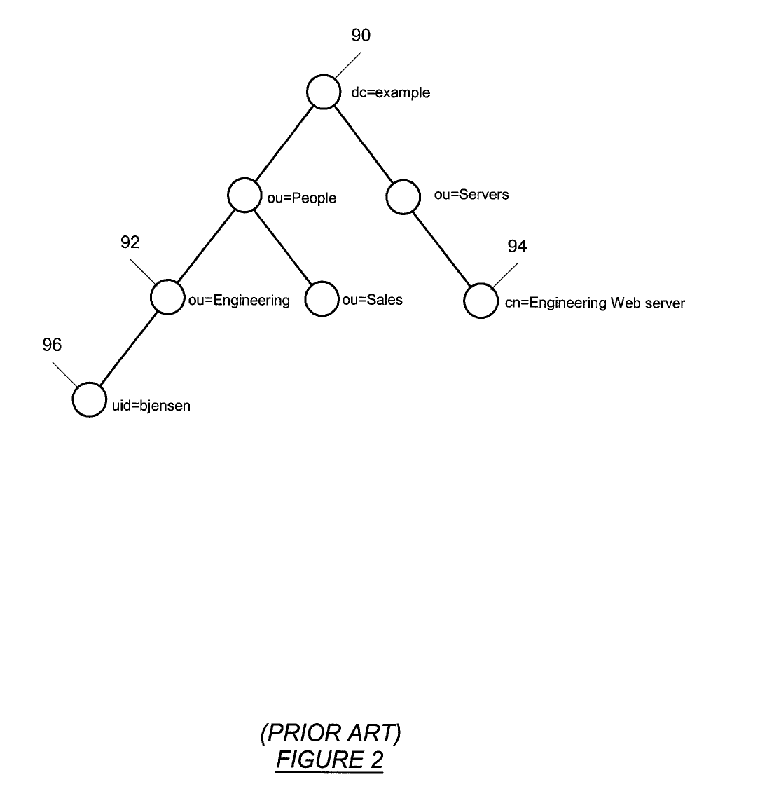

FIG. 3 illustrates the LDAP protocol used for a simple request.

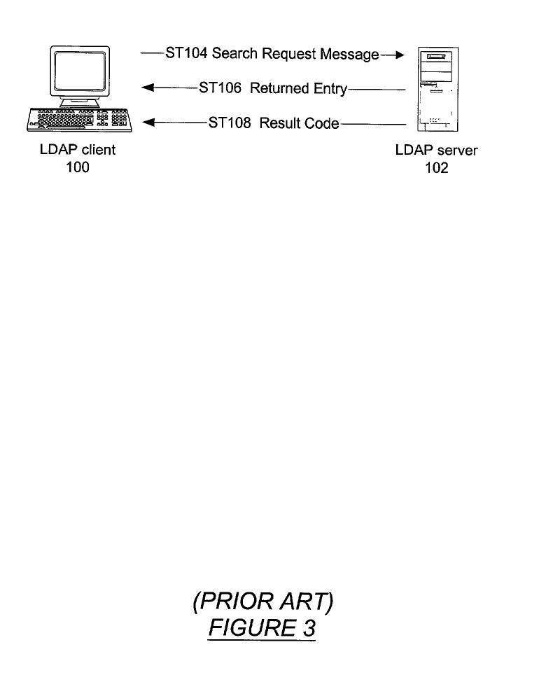

FIG. 4 illustrates a directory entry showing attribute types and values.

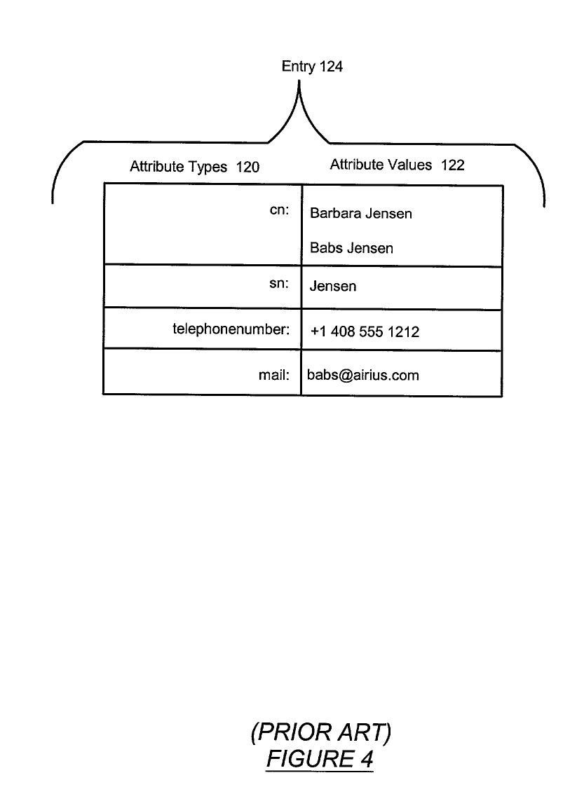

FIG. 5 illustrates a typical computer with components.

FIG. 6 illustrates a flow process of a virtual attribute service interface.

FIG. 7 illustrates a role with members.

FIG. 8 illustrates a flow process of generating an attribute value of a role service.

### DETAILED DESCRIPTION

Specific embodiments of the invention will now be described in detail with reference to the accompanying figures. Like elements in the various figures are denoted by like reference numerals for consistency.

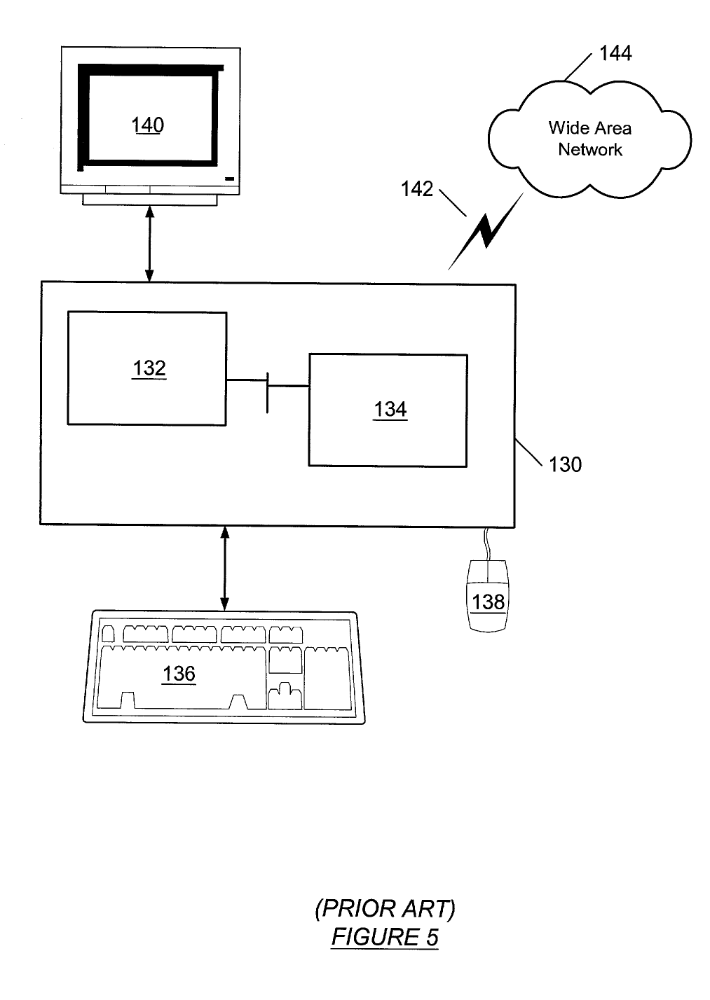

The invention described here may be implemented on virtually any type computer regardless of the traditional platform being used. For example, as shown in FIG. 5, a typical computer (130) has a processor (132), memory (134), among others. The computer (130) has associated therewith input means such as a keyboard (136) and a mouse (138), although in an accessible environment these input means may take other forms. The computer (130) is also associated with an output device such as a display (140), which also may take a different form in a given accessible environment. The computer (130) is connected via a connection means (142) to a wide area network (144), such as the Internet.

The Virtual Attribute Service (VAS) is a feature of iPlanet™ Directory Server (iDS) that allows for the implementation of role and class of service features. VAS is an interface that defines service providers to allow lifetime management of attribute values returned from a query to a service provider, and that can hide the true origins of an attribute value from a client application.

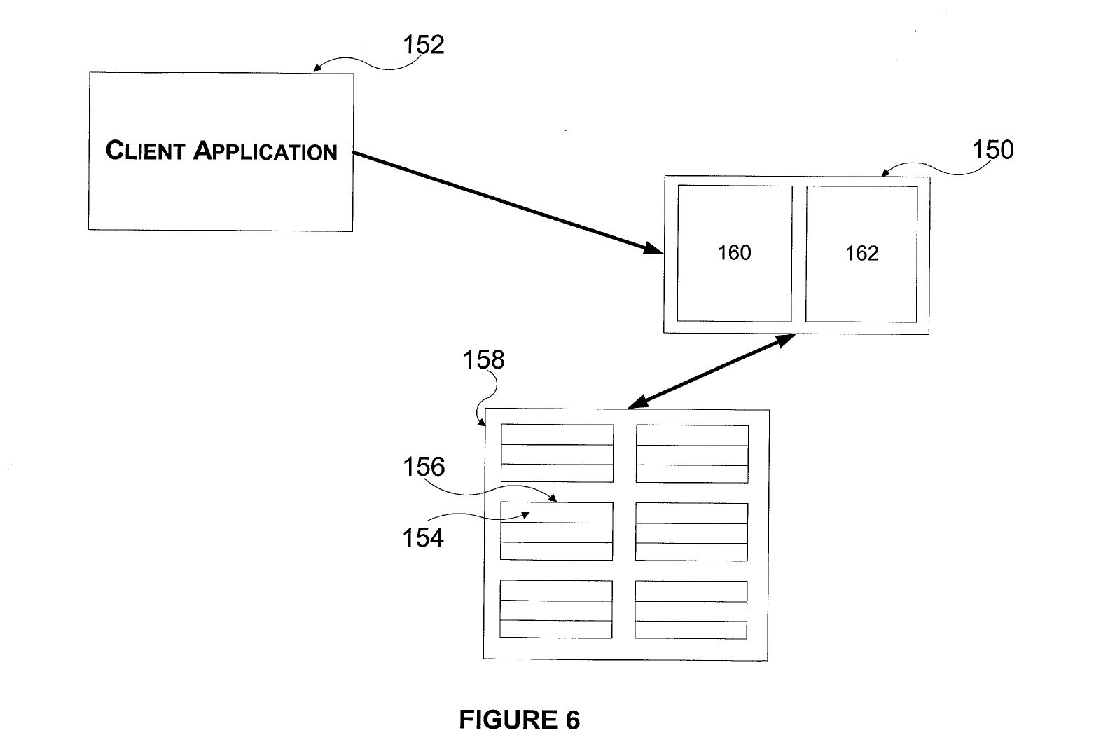

In accordance with one or more embodiments of the present invention, the VAS communicates with several components contained within the iDS (158) as shown in FIG. 6. One component is a client application (152). Another component is an entry (156). Another component is an attribute value (154) associated with the entry (156). The client application (152) (or server code) can call VAS as a single, common interface (150) to determine the attribute value (154) associated with a given entry (156) contained within an iDS (158), regardless of whether the attribute value is in fact contained within the entry.

The VAS is implemented by consulting one or more Virtual Attribute Service Providers (Service Provider), such as a role service (160) or a class of service (CoS) (162), within the common interface (150). A Service Provider may be implemented as a plugin to the iDS, as well as any number of other forms.

Still referring to FIG. 6, the attribute value (154) may be contained within the entry (156), generated by the role service (160) or generated by the class of service (CoS) (162). One skilled in the art can also appreciate that the attribute value (154) may also be generated by any number of other plugins or service providers that can generate the value.

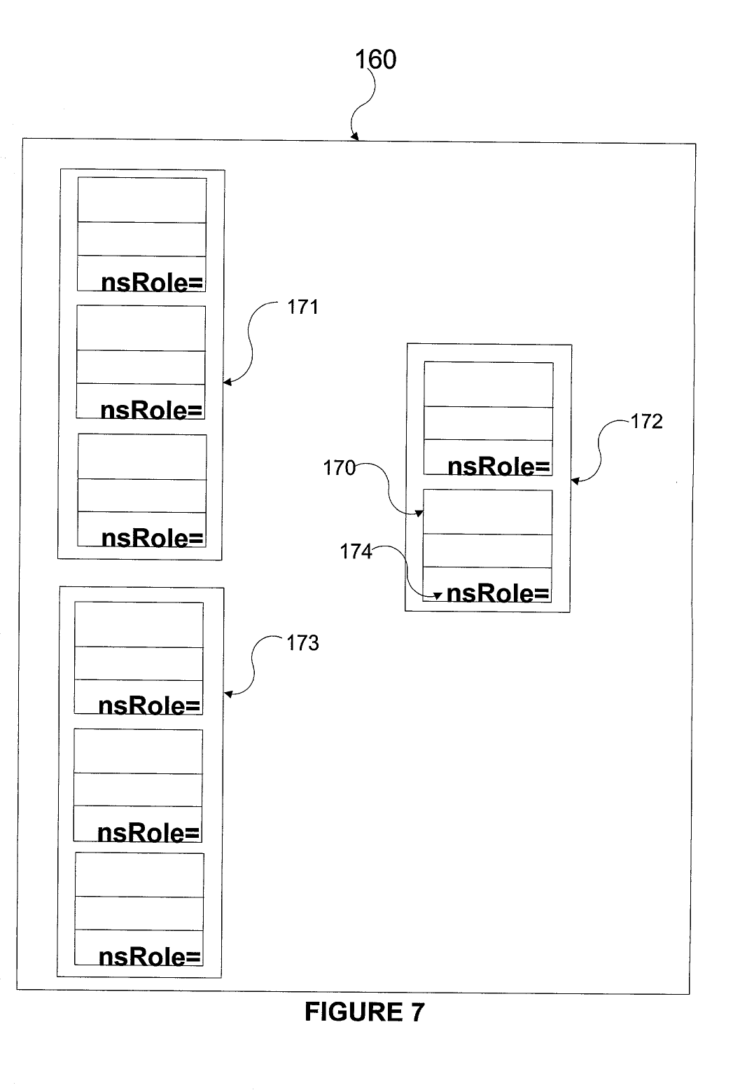

A role, as illustrated in FIG. 7, may be implemented by using the role service (160) plugin to the iDS that groups entries by members (170), which are the entries that possess a role. FIG. 7 depicts a first role (172), a second role (171), and a third role (173). Note that a role may have any number of members (170) containing any number of attributes. Each entry assigned to a role contains a special attribute called an nsRole attribute (174). The nsRole attribute (174) is computed to specify all the roles that belong to a particular entry, i.e. to determine role membership. The VAS maintains a mapping table which allows the VAS to translate quickly from a requested attribute to the role service.

The role service, as related to iDS, is used for membership enumeration, where a determination is made about which entries have a particular role. This allows for rapid resolution of queries for group members. Another use of the role service is to determine whether a particular entry possesses a particular role. The role service may also be assigned to and removed from a particular entry. The method for determining members using the role service allows a client application to locate and determine the particular role of a member. The role service may be implemented by using a role service plugin to the iDS.

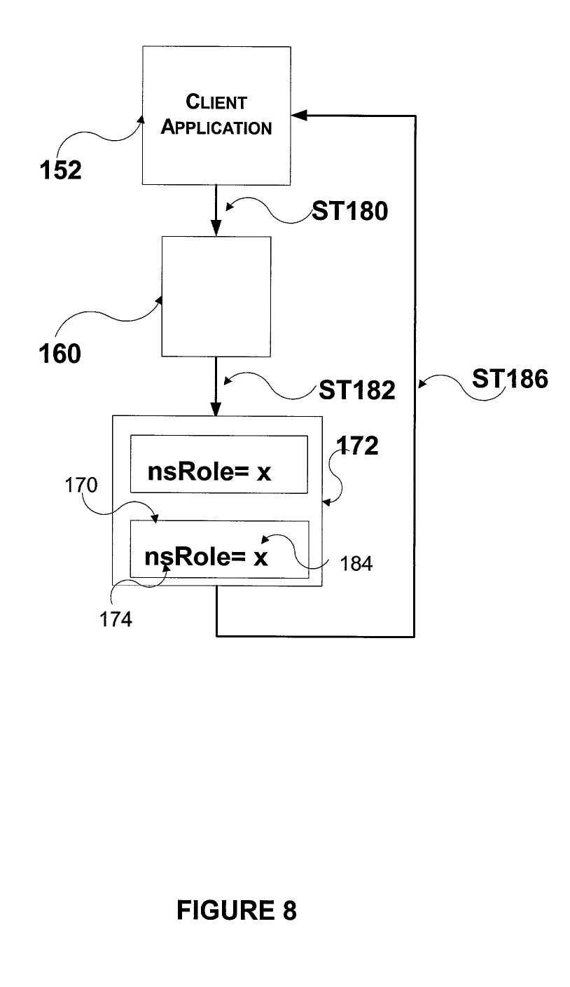

FIG. 8 illustrates a typical flow process for generating an attribute value of a role service in accordance with one or more embodiments of the present invention. The client application (152) sends a query (step 180) to a target entry that is interpreted by a role service interface (160). The role service interface (160) queries (step 182) the nsRole attribute (174) of each member (170) for an attribute value (184) to determines the entry's role membership (172). Once membership of the entry's role is determined, the attribute value (184) is returned (step 186) to the client application (152).

The way role membership is defined may include managed roles, filtered roles, and nested roles. Managed roles allow the creation of an explicit enumerated list of members. Filtered roles allow the assignment of entries to the role depending upon the attribute contained within the role. The filtered role specifies an LDAP filter that is compared to the entries. Entries that match the filter are said to possess the role. Nested roles allow the creation of roles that contain other roles. A role member may be specified either explicitly or on-the-fly. “On-the-fly” is a term referring to events that occur while the client application is accessing the iDS.

Access to the members of the role is controlled by defined rules that restrict modification access rights to just the nsRoleDN attribute. Access may also be defined such that a particular client is restricted to adding or removing a specific set of attribute values.

In accordance with one or more embodiments of the present invention, the CoS may be implemented by using a CoS plugin to the iDS that allows the iDS to share attributes between entries in a way that is transparent to client applications. With CoS, some attribute values may not be stored with the entry itself. The attribute values are generated on-the-fly as the entry is sent to the client application.

Using CoS allows attribute values that are common to many entries to be stored in one place. Thus, if an attribute value that is common to many entries need to be changed, the changes can be done in one place, instead of in each particular entry. To a client application, the virtual attribute values from the CoS appear just like all other attribute values.

A typical CoS arrangement includes at least two entries in the iDS. One entry is the CoS definition entry, which identifies the type of CoS being used. The CoS definition entry is stored as an LDAP subentry below the branch at which the CoS is effective. Another entry is a dynamic CoS template entry where a list of the shared attribute values are stored. The CoS definition entry and the dynamic CoS template entry interact to provide attribute values to their target entries, entries that are within the scope of and point to the CoS. Changes to attribute values of the dynamic CoS template entry are automatically applied to the entries sharing the attribute. Attributes can either point to the dynamic CoS template entry or have a static value.

There are several potential ways of implementing the CoS definition entry. One implementation is a pointer CoS that generates on-the-fly attribute values by identifying the dynamic CoS template entry using the template DN only. This is accomplished by adding a specific attribute to the entry, such as the object class cosPointerDefinition. Another implementation is an indirect CoS that generates on-the-fly attribute values by identifying the template entry using the value of one of the target entry's attributes. This is also accomplished by adding a specific attribute to the entry, such as the object class cosIndirectDefinition. Another implementation is a classic CoS that generates on-the-fly attribute values by identifying the template entry by both its DN and the value of one of the target entry's attributes. This is also accomplished by adding a specific attribute to the entry, such as the object class cosClassicDefinition. Access to attributes generated by the CoS is controlled by the server, which grants and denies access in the same manner as for regular stored attributes.

An example of a usage of CoS is for managing a user's email settings. The CoS definition entry would indicate the type of user, i.e., a regular user could be defined as cosRegularDefinition, as well as the type of CoS definition, such as cosClassicDefinition. The CoS template entry would contain a list of shared attributes, such as mailboxquota: 10000 and maysendexternail: TRUE.

The creation of recursive loops by the VAS is avoided by different approaches. One approach is to detect a loop as it occurs. This approach is implemented by maintaining a count for the number of times a query has passed through the virtual attribute interface. If the count exceeds some predetermined threshold, an error is flagged and the operation is aborted. Another approach to avoid recursive loops is to ensure that a loop never occurs. This approach is implemented by requiring that any configuration change within any individual service provider is first checked against the configuration of all the service providers. This determines whether a cycle has been created.

The VAS may use cache to reduce computer performance time needed to determine the attribute value. Cache is a type of memory used in computer systems, inserted between the processor and main memory. Cache is intended to reduce the processing time discrepancy between the speeds of the processor and main memory. Virtual attribute values are cached where the normal attributes are in the entry's cache in order for the computer to be able to more quickly query and resolve the attribute values. If an entry that has attribute values that are cached is changed, and the change involves either the nsRole or cosDefinition attribute, the entire entry's cache is invalidated. This form of entry caching makes virtual attributes indistinguishable on many levels from normal attributes of the iDS.

Several features add to the robustness of the VAS. One feature is an administrative framework that provides administrative functions, which are comprehensive functions for subsystems the framework knows, and those it does not know, without having two different ways of performing this task. Another feature is an indexing method where virtual attributes are indexed in a manner that change to the attribute value triggers a notification system that informs the subsystems of the change. Another feature is searching where searching the attribute values is accomplished by filter tests. Indexing and searching are features that complement each other in that an indexed VAS is more easily searched. Indexing and searching make the virtual attribute appear like normal attributes of the iDS.

Advantages of the present invention may include one or more of the following. The VAS makes attribute management easier by providing a mechanism for grouping and searching attribute values. Additionally, by storing attribute values in role service and CoS, changes made to the attribute value may be more easily and efficiently effected. The storage of attribute values in centralized locations, accessible to role members and CoS, reduces the computer system's storage requirements by allowing a single attribute value that is widely shared to be stored only once. The VAS also allows the implementation of an entry distribution system, such as a chaining backend method, to function properly, even though entries may be dispersed to numerous servers. Virtual attributes give the illusion that all entries are stored on the same server. Furthermore, using cache to store the virtual attribute values improves the computer's performance time needed to resolve a query. Those skilled in the art will appreciate that the present invention may have further advantages.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A virtual attribute service in a directory server, comprising:
an attribute value associated with an entry;
a virtual attribute service provider; and
an interface using the virtual attribute service provider to generate the attribute value associated with the entry.

2. The virtual attribute service of claim 1, wherein the attribute value is not physically contained within the entry.

3. The virtual attribute service of claim 1, wherein the virtual attribute service provider comprises a role service.

4. The virtual attribute service of claim 1, wherein the virtual attribute service provider comprises a class of service.

5. The virtual attribute service of claim 1, wherein the virtual attribute service provider is implemented as a plugin to the directory server.

6. A method of generating a value of a virtual attribute, comprising:
calling a virtual attribute service by an executable application; and
consulting a virtual attribute service provider within a common interface of the virtual attribute service;
wherein the value of the virtual attribute is generated by the virtual service provider accessed by the common interface.

7. The method of claim 6, further comprising:
using a memory cache to store the value of the virtual attribute.

8. The method of claim 6, further comprising:
maintaining a count for a number of times a query passes through the common interface; and
flagging an error and aborting the execution of the virtual attribute service if the count exceeds a threshold number.

9. The method of claim 6, further comprising:
checking a configuration change within a service provider against the configuration of all service providers;
determining whether a cycle is created; and
flagging an error and aborting the execution of the virtual attribute service if a cycle is created.

10. The method of claim 6, wherein the virtual attribute service provider comprises a role service.

11. The method of claim 6, wherein the virtual attribute service provider comprises a class of service.

12. The method of claim 6, wherein the virtual attribute service provider is implemented as a plugin to the directory server.

13. A method of generating a value of a virtual attribute, comprising:
calling a virtual attribute service by an executable application;
consulting a virtual attribute service provider within a common interface of the virtual attribute service;
using a memory cache to store the value of the virtual attribute;
maintaining a count for the number of times a query passes through the common interface;
flagging an error and aborting the execution of the virtual attribute service if the count exceeds a threshold number;
checking a configuration change within a service provider against the configuration of all service providers;
determining whether a cycle is created; and
flagging an error and aborting the execution of the virtual attribute service if a cycle is created;
wherein the value of the virtual attribute is generated by the virtual service provider accessed by the common interface.

14. A class of service in a directory server, comprising:
a definition entry identifying a type of class of service; and
a dynamic template entry storing a list of the shared attribute values;
wherein the definition entry and the dynamic template entry interact to provide an attribute value to a target entry.

15. The class of service of claim 14, wherein the definition entry is stored as a subentry in a directory information tree below a branch at which the class of service is effective.

16. The class of service of claim 14, wherein the target entry comprises an entry pointing to the class of service.

17. The class of service of claim 14, wherein changes to the attribute value of the dynamic template entry are applied to all entries sharing the attribute value.

18. A method for generating an attribute value of a class of service in a directory server, comprising:
identifying a dynamic template entry by a distinguished name;
adding a specific attribute to the dynamic template entry; and
generating the attribute value of the dynamic template entry while a client application is accessing the directory server.

19. The method of claim 18, wherein the specific attribute is a cosPointerDefinition object class.

20. A method for generating an attribute value of a class of service in a directory server, comprising:
identifying a dynamic template entry by an attribute value of a target entry;
adding a specific attribute to the dynamic template entry; and
generating an attribute value of the dynamic template entry while a client application is accessing the directory server.

21. The method of claim 20, wherein the specific attribute is a cosIndirectDefinition object class.

22. A method for generating an attribute value of a class of service in a directory server, comprising:
identifying a dynamic template entry by a distinguished name and an attribute value of a target entry;
adding a specific attribute to the dynamic template entry; and
generating an attribute value of the dynamic template entry while a client application is accessing the directory server.

23. The method of claim 22, wherein the specific attribute is a cosClassicDefinition object class.

24. An apparatus for generating a value of a virtual attribute, comprising:
means for calling a virtual attribute service by an executable application; and
means for consulting a virtual attribute service provider within a common interface of the virtual attribute service;
wherein the value of the virtual attribute is generated by the virtual service provider accessed by the common interface.
